(19) United States
(12) Patent Application Publication
(10) Pub. No.: US 2025/0150188 A1
(43) Pub. Date: May 8, 2025

(54) Audio signal distribution for the thermal optimisation of speakers

(71) Applicant: SAGEMCOM BROADBAND SAS, Bois-Colombes (FR)

(72) Inventors: Gilles BOURGOIN, Bois-Colombes (FR); Guillaume NAVION, Bois-Colombes (FR)

(21) Appl. No.: 18/940,758

(22) Filed: Nov. 7, 2024

(30) Foreign Application Priority Data
Nov. 7, 2023 (FR) FR2312068

(51) Int. Cl. H04H 20/89; H04R 29/00

(52) U.S. Cl. CPC H04H 20/89; H04R 29/002

(57) ABSTRACT

A method for broadcasting an audio signal through an audio system, including a plurality of audio channels, includes broadcasting the audio signal by using a primary distribution of the audio signal; evaluating the temperature of a speaker; when the temperature of the speaker becomes greater than a first temperature threshold, modifying the primary distribution to obtain an optimised distribution of the audio signal, in which the primary audio signal of the speaker is applied at least partially to at least one other audio channel; and broadcasting the audio signal by using the optimised distribution.

The invention relates to the field of multichannel audio systems, integrated in one or more pieces of audio playback equipment.

### BACKGROUND OF THE INVENTION

A set-top box (STB) is a piece of electrical equipment the primary function of which is to acquire an audio-video stream, to decode this stream, and to have the video signal broadcast by a television and the audio signal broadcast by the speakers of the television and/or optionally by other audio playback equipment (soundbar, smart speaker enclosures, etc.).

Certain recent set-top boxes integrate one or more speakers. The speaker(s) can be used in a voice assistant function, even to implement a multichannel audio system.

The multichannel audio system thus comprises one or more audio channels comprising one or more speakers of the set-top box, as well as optionally audio channels comprising equipment speakers connected to the set-top box (soundbar and/or smart speaker enclosures, for example).

The design of such a set-top box and, more generally, of any compact piece of equipment integrating one or more speakers, causes difficulties regarding heat dissipation, as all the components, including the speakers, are located in a very reduced space and have little or no ventilation. Consequently, the speakers can be very thermally stressed in their reduced air volume, which affects their service life.

A certain number of solutions of the prior art are known to attempt to resolve this problem.

A known solution consists of controlling, according to the temperature, the power sent to the speaker after the amplifier. This solution therefore requires an analogue-to-digital converter to measure and digitise the signal at the output of the amplifier, as well as a sensor measuring the temperature of the speaker to be protected. The signal is attenuated if the measured temperature exceeds a limit defined by the manufacturer.

Another known solution consists of connecting a resistive circuit to the magnet of the speaker to be protected. The resistance of this circuit varies with the temperature of the magnet. The resistance is therefore measured, and the temperature is deduced therefrom. The information is transmitted to a signal limiter. The audio signal is attenuated if the estimated temperature exceeds a limit defined by the manufacturer.

These known solutions have the following disadvantages.

They require sensors and electronic components to be added, which increases the complexity and the cost of the equipment in which they are integrated.

In addition, these solutions all propose to protect the speaker by attenuating the signal sent in case of exceeding the limit temperature. This results in a drop in the overall sound level of the product and therefore a clear deterioration in the user experience.

### AIM OF THE INVENTION

The invention aims for a solution which makes it possible to limit the risks of premature degradation and therefore to increase the service life of the speakers of a multichannel audio system, said solution being simple and inexpensive to implement, and not degrading the user experience.

### SUMMARY OF THE INVENTION

In view of achieving this aim, a method is proposed for broadcasting a multichannel audio signal through an audio system comprising a plurality of audio channels each comprising at least one speaker, the broadcasting method being implemented by a processing unit and comprising the steps of:
broadcasting the multichannel audio signal by using a primary distribution of the multichannel audio signal, which defines a primary audio signal for each audio channel, and by applying said primary audio signals to the audio channels;
evaluating an operating temperature of at least one particular speaker belonging to a particular audio channel;
when the operating temperature of the particular speaker becomes greater than a first predefined temperature threshold, modifying the primary distribution to obtain an optimised distribution of the multichannel audio signal, in which a particular primary audio signal of the particular audio channel is applied at least partially to at least one other audio channel, the optimised distribution thus defining an optimised audio signal for each audio channel;
broadcasting the multichannel audio signal by applying the optimised audio signals to the audio channels until the operating temperature of the particular speaker becomes less than a second predefined temperature threshold.

Thus, when a speaker heats up or risks heating up too much, the processing unit at least partially distributes the audio signal from said speaker to the other audio channels, until the temperature of said speaker is standardised. The overheated audio channel is thus virtually reproduced, and the temperature of the speaker is thus reduced without degrading the user experience. This limits the risk of premature degradation and increases the service life of the speakers.

The temperature of the speakers can be evaluated without adding a temperature sensor in the piece of electrical equipment. Implementing the broadcasting method therefore requires no (or very few) additional electronic components (hardware), and is therefore simple and inexpensive to implement.

In addition, a broadcasting method such as described above is proposed, in which the modification of the primary distribution comprises the step of applying at least some of an overall level of the particular primary audio signal to at least one other audio channel.

In addition, a broadcasting method such as described above is proposed, the plurality of audio channels comprising a central channel and two side channels, the particular audio channel being the central channel, at least some of the overall level of the particular primary audio signal being applied to the two side channels.

In addition, a broadcasting method such as described above is proposed, the plurality of audio channels comprising a central channel, two front side channels and two rear side channels, the particular audio channel being a particular side channel, at least some of the overall level of the particular primary audio signal being applied to the central channel and to another side channel on one same side as said particular side channel.

In addition, a broadcasting method such as described above is proposed, the plurality of audio channels comprising two front side channels and two rear side channels, the particular audio channel being a front (or rear) side channel, at least some of the overall level of the particular primary audio signal being applied to another side channel on one same side as said particular side channel, and on the other front (or rear) side channel.

In addition, a broadcasting method such as described above is proposed, in which the modification of the primary distribution comprises the step of applying at least some frequency components of the particular primary audio signal to at least one other audio channel.

In addition, a broadcasting method such as described above is proposed, in which the modification of the primary distribution comprises the step of modifying a cut-off frequency of a crossover filter.

In addition, a broadcasting method is such as described above is proposed, the plurality of audio channels comprising a low-frequency channel and at least one other audio channel, the particular audio channel being one of the at least one other audio channel, frequency components of frequencies less than a predefined frequency threshold of the particular primary audio signal being applied to the low-frequency channel.

In addition, a broadcasting method such as described above is proposed, in which the step of applying at least some of the frequency components of the particular primary audio signal to at least one other audio channel is implemented if a number of particular speakers, the operating temperature of which becomes greater than the first predefined temperature threshold, is greater than a predefined number.

In addition, a broadcasting method such as described above is proposed, in which the particular primary audio signal continues to be partially applied to the particular audio channel until the operating temperature of the particular speaker becomes less than the second predefined temperature threshold.

In addition, a broadcasting method such as described above is proposed, in which the particular primary audio signal is progressively attenuated over the particular audio channel.

In addition, a broadcasting method such as described above is proposed, in which the evaluation of the operating temperature of the particular speaker comprises the steps of:
performing a frequency analysis of the particular primary audio signal to evaluate levels of different frequency components of the particular primary audio signal;
evaluating a real-time temperature of the particular speaker according to said levels.

In addition, a broadcasting method such as described above is proposed, comprising the step of applying an ADSR envelope to the real-time temperature to obtain the operating temperature.

In addition, a broadcasting method such as described above is proposed, in which the operating temperature is a future temperature.

In addition, a broadcasting method such as described above is proposed, in which the evaluation of the operating temperature is based on an analysis of the particular primary audio signal performed prior to its broadcasting.

In addition, a broadcasting method such as described above is proposed, in which the evaluation of the operating temperature is performed from a past temperature and a current temperature.

In addition, a broadcasting method such as described above is proposed, comprising the step of implementing a servo-controller, which receives, at the input, a setpoint and a measurement, and which produces a command at the output, the setpoint being a maximum temperature, the measurement being the evaluation of the operating temperature, and the command being a part of the particular primary audio signal to be applied to the at least one other audio channel.

In addition, a piece of equipment comprising a processing unit is proposed, in which the broadcasting method such as described above is implemented.

In addition, a piece of equipment such as described above is proposed, the piece of equipment being a set-top box.

In addition, a piece of equipment such as described above is proposed, in which the set-top box integrates at least one speaker of the plurality of audio channels.

In addition, a computer program is proposed, comprising instructions which make the processing unit of the equipment such as described above execute the steps of the broadcasting method such as described above.

In addition, a computer-readable recording medium is proposed, on which the computer program such as described above is recorded.

The invention will be best understood, in the light of the description below of particular, non-limiting embodiments of the invention.

### BRIEF DESCRIPTION OF THE DRAWINGS

Reference will be made to the accompanying drawings, among which:

FIG. 1 represents a multichannel audio system;

FIG. 2 is a graph comprising a measurement curve of the temperature of a speaker according to time, an equivalent curve, but without an applied signal, and an equivalent theoretical curve;

FIG. 3 is a graph comprising a curve of the temperature of a speaker according to the frequency, and a curve of the power of the audio signal applied according to its frequency;

FIG. 4 is a graph comprising a curve of the impedance of a speaker according to the frequency;

FIG. 5 is a graph comprising a curve of an ADSR envelope;

FIG. 6 is a figure similar to FIG. 1, illustrating a first overheating scenario;

FIG. 7 is a figure similar to FIG. 1, illustrating a second overheating scenario;

FIG. 8 is a figure similar to FIG. 1, illustrating a third overheating scenario;

FIG. 9 is a figure similar to FIG. 1, illustrating a fourth overheating scenario;

FIG. 10 illustrates the processing by a mixing matrix of input audio signals to produce output audio signals;

FIG. 11 represents a first mixing matrix;

FIG. 12 represents a second mixing matrix, corresponding to a primary distribution of the multichannel audio signal;

FIG. 13 represents the second mixing time corresponding to an optimised matrix, this distribution;

FIG. 14 is a graph comprising a curve of the frequency response of a speaker of a central channel and of a woofer;

FIG. 15 represents the steps of the broadcasting method;

FIG. 16 represents a block diagram implemented in the processing unit to implement the broadcasting method.

### DETAILED DESCRIPTION OF THE INVENTION

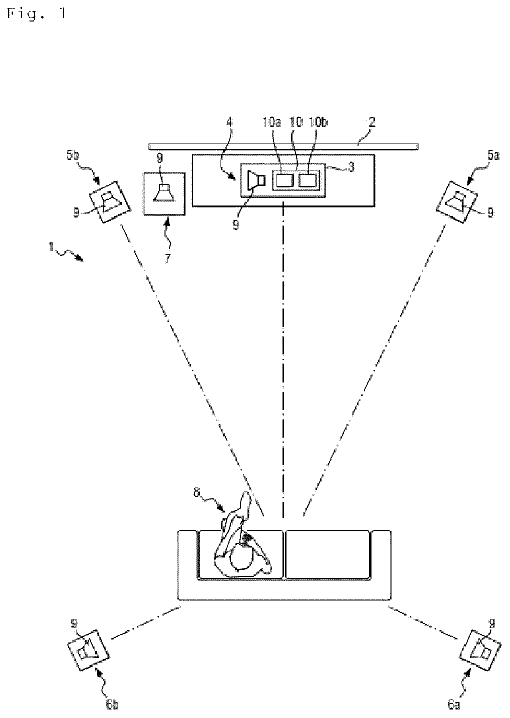

In reference to FIG. 1, a multichannel audio system 1 is integrated in an audio-video playback system comprising a television 2 and a set-top box 3.

The multichannel audio system in this case comprises a plurality of audio channels comprising a central channel 4, two front side channels 5a, 5b (right and left), two rear side channels 6a, 6b (right and left) and a low-frequency channel 7.

In this case, “front” means the side channels closest to the television 2 and the “rear” means the side channels closest to the ideal listening location, also called sweet spot, of the listener 8.

In the 5.1 format, the front-right channel 5a corresponds to the right channel, the front-left channel 5b to the left channel, the central channel 4 to the centre channel, the rear-right channel 6a to the side and rear-right surround channel, the rear-left channel 6b to the side and rear-left surround channel, and the low-frequency channel 7 to the LFE (low frequency effects) channel.

In this case, the central channel 4 is integrated in the set-top box 3. The side channels 5a, 5b, 6a, 6b are each integrated in smart speaker enclosures (therefore four smart speaker enclosures). The low-frequency channel 7 is integrated in a subwoofer.

The set-top box 3 therefore integrates at least one speaker 9. All the speakers 9 of the different channels are “midrange” (or medium, medial) type speakers, except the speaker of the low-frequency channel 7, which is a “boomer” or “woofer” speaker.

The design of midrange speakers is optimised for playing back medium frequencies and high frequencies (frequencies, for example, of between 500 Hz and 5 kHz).

The design of the boomer speaker is optimised for playing back low frequencies (frequencies, for example, of between 50 Hz and 500 Hz).

It must be noted that the invention can be implemented in a multichannel audio system which is different from that of FIG. 1. The invention applies to any type of multichannel audio system. In particular, it would be possible to integrate several, even all of the audio channels (and therefore all of the speakers 9) in the set-top box 3.

The set-top box 3 comprises a processing unit 10 (electronic and software). The processor module 10 comprises at least one processing component 7, which is for example, a “general purpose” processor, a processor specialising in signal processing (or DSP, for Digital Signal Processor), a processor specialising in artificial intelligence algorithms (NPU-type, for Neural Processing Unit), a microcontroller, or a programmable logic circuit such as an FPGA (for Field Programmable Gate Arrays) or an ASIC (for Application Specific Integrated Circuit).

The processing unit 10 also comprises one or more memories 10b, connected to or integrated in the processing component 10a. At least one of these memories 10b forms a computer-readable recording medium, on which at least one computer program is stored, comprising instructions which cause the processing component 10a to execute at least some of the steps of the broadcasting method which will be described.

The broadcasting method is a method for broadcasting a multichannel audio signal.

The multichannel audio signal, for example (but not necessarily), comes from an audio-video stream, the video signal being broadcast by the television 2.

The processing unit 10 of the set-top box 3 normally broadcasts the multichannel audio signal by using a primary distribution of the multichannel audio signal, which defines a primary (distinct) audio signal for each audio channel. The processing unit 10 applies said primary audio signals to the audio channels. However, when the temperature of one or more speakers 9 becomes too high, the processing unit 10 modifies this primary distribution to reduce the temperature of said speaker(s) 9.

The processing unit 10 therefore evaluates an operating temperature of at least one particular speaker 9 belonging to a particular audio channel. In this case, the processing unit 10 evaluates the operating temperature of each speaker 9 of the multichannel audio system 1.

When the operating temperature of a particular speaker 9 of a particular audio channel becomes greater than a first predefined temperature threshold, the processing unit 10 modifies the primary distribution to obtain an optimised distribution of the multichannel audio signal, in which the particular primary audio signal of the particular audio channel is applied at least partially to at least one other audio channel. The first predefined temperature threshold can be different according to the audio channels and the speakers 9.

The audio signal on the speaker 9 is therefore reduced, the temperature of which is too high, and it is distributed on one or more other audio channels.

The optimised distribution thus defines an optimised (distinct) audio signal for each audio channel. The processing unit 10 broadcasts the multichannel audio signal by applying the optimised audio signals to the audio channels until the operating temperature of the particular speaker 9 becomes less than a second predefined temperature threshold. The second predefined temperature threshold can be equal to the first predefined temperature threshold, but not necessarily. The second predefined temperature threshold can be different according to the audio channels and the speakers 9.

For each speaker 9, the evaluation of the temperature of said speaker 9 is, in this case, performed without a temperature sensor.

The operating temperature is evaluated according to a temperature evaluation method described below. In this case, in an embodiment, the operating temperature is the current temperature, i.e. the temperature at the present time. It must be noted that the temperature evaluation method can also make it possible to evaluate the temperature at a future time (“future temperature” is referred to).

Theoretical analyses and laboratory measurements have made it possible to determine the evolution of the temperature of a speaker over time, at a fixed frequency.

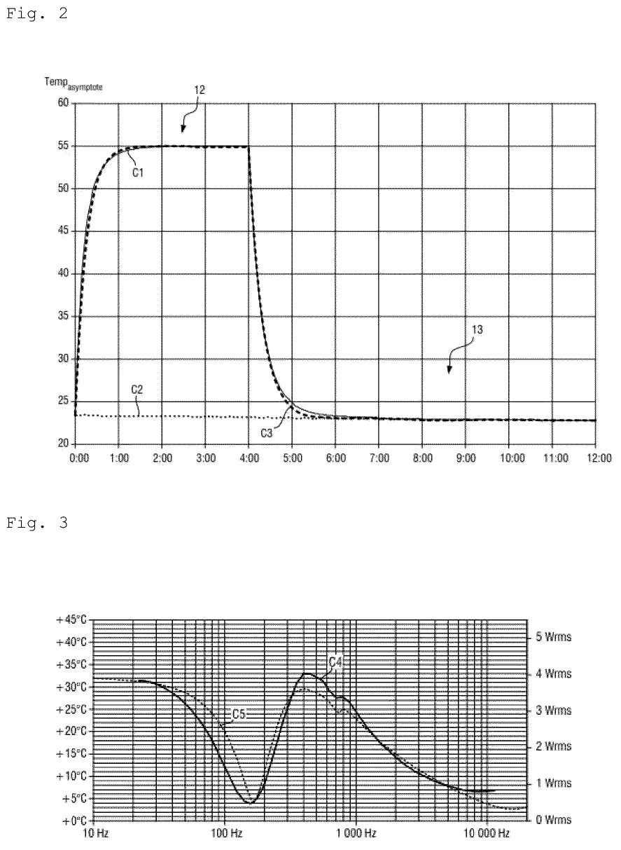

The curve C1, in FIG. 2, represents the time evolution of the temperature of a speaker, while an audio signal is applied (zone 12), then without an applied audio signal (zone 13). This curve C1 has been obtained from measurements taken with a fixed frequency of 1 kHz, with a 1 W power audio signal at the input of the speaker. The curve C2 is a curve equivalent to the curve C1, while no audio signal is applied.

Based on these tests, the mathematical laws of increase and decrease of the temperature Temp(time) of a speaker over time have been deduced according to the following formulae (curve C3):
For the increasing part of the curve C3:

$$Temp ( time ) = {Temp}_{init} + ( {Temp}_{asymptote} - {Temp}_{init} ) . ( 1 - {e}^{Q . ( time - {time}_{init} )} )$$

For the decreasing part of the curve C3:

$$Temp ( time ) = {Temp}_{init} + ( {Temp}_{asymptote} - {Temp}_{init} ) . {e}^{Q . ( time - {time}_{init} )}$$

The coefficient Q is representative of the specific heat capacity of the system. This parameter is fixed and can be evaluated in the laboratory. It is around 0.001.

The same applies for Temp_{asymptote} which depends on the speaker, its environment (fixed parameters), and the level of the audio signal applied at the terminals of the speaker, which is known. For a 2 W electrical signal, Temp_{asymptote} is around 70° C. In FIG. 2, it is around 55° C.

The initial temperature of the speaker Tempᵢₙᵢₜ (equal to 25° C., for example) is also known, as its value is based on the ambient temperature of the piece of equipment and on the thermal evolution of the system according to the two previously formulated laws, including the time of application of the known signal, also.

It is therefore understood that at an instant t, the temperature of a speaker depends on the following parameters:
The ambient temperature;
The level of the signal sent at the terminals of the speaker;
The initial temperature of the speaker (Tempᵢₙᵢₜ);
The time of application of the signal timeᵢₙᵢₜ.

The ambient temperature is supplied to the processing unit 10 by a sensor integrated in the set-top box 3. All (or almost all) modern digital electrical equipment indeed comprises a heat sensor. The temperature sensor is therefore already present and is not dedicated to the implementation of the broadcasting method described in this case.

The temperature of the speaker 9 also depends on the frequency of the audio signal.

At an equal electrical voltage at the terminals of a speaker (for example, 2 Vrms), using a single-frequency audio signal, the increase of the temperature of the speaker depends on the frequency of the audio signal applied to its terminals. This is explained, as the impedance of a speaker (mounted in a speaker enclosure, or not) depends on the frequency of the audio signal.

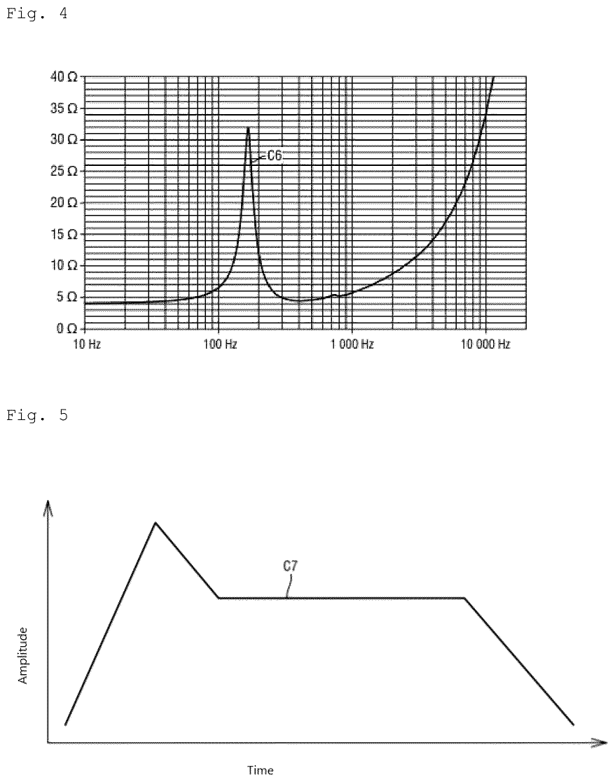

FIG. 3 shows the increase of the temperature according to the frequency (curve C4), and the electrical power of the audio signal according to the frequency (curve C5).

FIG. 4 shows the impedance of the speaker according to the frequency of the audio signal applied to its terminals (curve C6).

The power at the terminals of the speaker can be estimated by the following formula:

$$Power = {voltage}^{2} / impedance$$

By comparing the increase of the temperature by frequency with the power at the terminals of the speaker, a similarity is observed, which is consistent with the basic thermal rules:

$$Temperature = Constant \times Power$$

The “real” audio signal, applied at the terminals of each speaker 9 of the multichannel audio system 1, comprises a plurality of frequency components, each associated with a power level.

The increase of temperature of a speaker which plays back this audio signal, and therefore the temperature of said speaker can therefore be defined, by knowing the frequency distribution of the audio signal.

The processing unit 10, in this case, performs an FFT (Fast Fourier Transform) calculation, to know the frequency distribution of the audio signal. The processing unit 10 therefore determines frequency components each associated with a power level.

The processing unit 10 then determines the increase of temperature of the speaker 9 resulting from the contributions of each of these frequency components, using the mathematical laws described above.

For each speaker 9, the processing unit 10 therefore performs a frequency analysis of the primary audio signal applied to the audio channel comprising said speaker 9 to evaluate levels of different frequency components of the primary audio signal, then evaluates a real-time temperature of the speaker 9 according to said levels (and of the ambient temperature, of the initial temperature and of the time of application of the signal).

The processing unit 10 therefore continuously knows the real-time temperature of each speaker 9 at time t.

In order to ensure system stability at the system and user perception scale, edge effects must be considered. If a highly dynamic approach with instantaneous system response is considered, the application of the correction will lead to a compensation for thermal risks and therefore revert the system to a state of equilibrium, thereby reducing the action of the method. The system risks oscillating between states of equilibrium and risk, potentially disrupting the user experience through incessant back-and-forth movements. This is what a “pumping” effect is assimilated to, from a dynamic point of view.

Certain dynamic algorithms, like audio compressors, for example, integrate solutions to prevent these oscillation effects.

These solutions generally present themselves in the form of four parameters grouped together in a set called ADSR (Attack Decay Sustain Release) envelope.
Attack: this is the time duration necessary to reach the maximum action level of the algorithm after exceeding the threshold. This time is typically equal to a few minutes;
Decay: this is the time duration necessary to reduce the action of the algorithm after the attack peak. This time is typically equal to a few minutes;
Sustain: this is the action level of the algorithm maintained while the signal is maintained beyond the trigger threshold.
Release: this is time duration necessary such that the effect of the algorithm is dissipated completely after falling back under the trigger threshold. This time is typically equal to a few minutes.

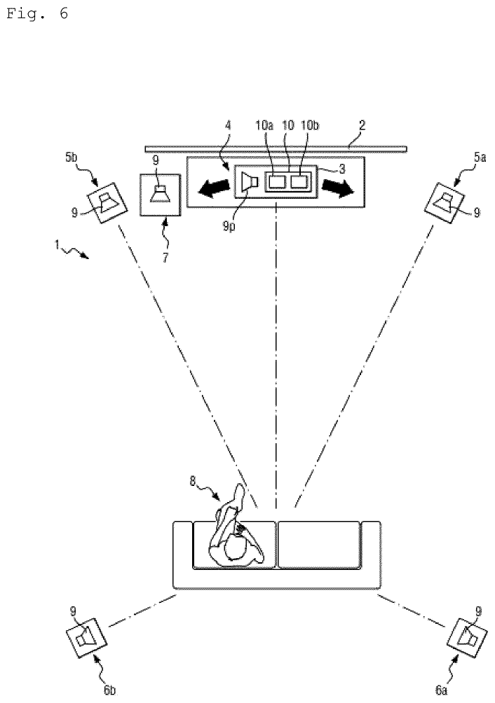

An ADSR envelope is shown in FIG. 5 (curve C7).

In this case, in a clever and original way, the ADSR envelope is applied not to the audio signal, but to the real-time temperature, which is evaluated as has just been explained.

In this case, for example, the following values are used for the parameters of the envelope:
Attack: 5 mn;
Decay: 5 mn;
Release: 5 mn.

These parameters can be adjusted to react to different stresses. In this case, it is appropriate to approach the values making it possible to smooth the effect of the algorithm over quite long periods of time.

It must be noted that, for a speaker 9 integrated in a set-top box 3, the limit temperature for using the speaker 9 is usually around 80° C. (this value being indicated precisely on the data sheet of the speaker 9, and naturally depends on the model of the speaker 9).

Given the inertia, a safe temperature threshold can be 15° C. under this threshold to ensure that the critical temperature is not reached.

In FIG. 2, which shows the time evolution of the temperature of a speaker 9 with an audio signal at the input and then without an audio signal, it can be seen that the temperature stabilises after a certain time, to reach the value Temp_{asymptote}.

This value corresponds to the thermal stabilisation of the system for a simple signal and of constant level.

Yet, an audio signal actually encountered, such as music, a voice, etc., fluctuates. The stabilisation is determined dynamically by integrating the instantaneous level of the signal and its frequency distribution, smoothed by an envelope coefficient.

The real-time temperature comprises digital samples which are applied at the input to a digital filter forming the ADSR envelope. The digital samples at the output of the filter are the values of the current temperature.

For each speaker 9, the processing unit 10 therefore applies an ADSR envelope to the real-time temperature to obtain the current temperature.

For each speaker 9 of the different audio channels, the processing unit 10 knows the current temperature of said speaker 9 and therefore the margin with respect to the limit temperature for using said speaker 9, using the thermal feedback based on the predictive calculation described above.

When a particular (or several) speaker(s) 9 exceed(s) the first predefined temperature threshold, which risks causing dangerous overheating for the speaker (temperature >80° C., for example), the processing unit 10 distributes its particular primary audio signal over one or more other audio channels, dynamically and in a balanced manner, which makes it possible to reduce the temperature of the particular speaker without reducing the overall sound level or degrading the user experience.

For example, the first predefined threshold is equal to 65° C. (i.e. 15° C. under the “dangerous” temperature of 80° C.). The processing unit 10 therefore modifies the primary distribution to obtain an optimised distribution of the multichannel audio signal. The optimised audio signals are applied to the audio channels until the current temperature of the particular “overheating” speaker 9 becomes less than a second predefined temperature threshold. For example, (but not necessarily), the second predefined temperature threshold is also equal to 65° C.

Attention is now given to choosing audio channels over which the particular primary audio signal(s) is/are at least partially transferred. A few scenarios which can occur in the audio system 1 are presented.

The first scenario is applicable for an audio system comprising a central channel and (at least) two side channels. The particular audio channel, comprising the particular overheating speaker 9 is, in this case, the central channel 4. In this case, at least some of the overall level of the particular primary audio signal is applied to both side channels.

By “overall level”, this means, in this case, a level corresponding to the sum of the acoustic energy provided by all the frequency components of the signal.

In this case, in reference to FIG. 6, the particular speaker 9p, the operating temperature of which becomes greater than the first predefined temperature threshold is therefore the speaker of the central channel 4.

For example, the primary audio signal of said central channel 4 is applied to the two front side channels (front-right channel 5a and front-left channel 5b).

The primary audio signal of the central channel 4 continues to be partially applied to the central channel 4 while being progressively attenuated (for example, for one minute), until the operating temperature of the speaker 9p of the central channel 4 becomes less than the second predefined temperature threshold and therefore until a restoration of the temperature which will make the speaker 9p safe after stabilisation. In this case, “partially” means some of the overall level of the primary audio signal.

In the same proportions, the primary audio signal removed from the central channel 4 will be identically offset over the speakers 9 of the front-right 5a and front-left 5b channels, to create a virtual central channel, thus alleviating the speaker 9 of the central channel 4 without any degradation nor spatialisation, nor of the overall sound level.

It must be noted that in this first scenario, the primary audio signal of the central channel 4 could also be applied to the rear side channels 6a, 6b. The first scenario can thus be implemented, even when the audio system has only two side channels (i.e. front-right and front-left or rear-right and rear-left).

The second scenario is applicable for an audio system comprising a central channel, two front side channels and two rear side channels (at least). The particular audio channel, comprising the particular overheating speaker, is a particular side channel.

In this case, at least some of the overall level of the particular primary audio signal is applied to the central channel 4 and to another side channel on one same side as said particular side channel.

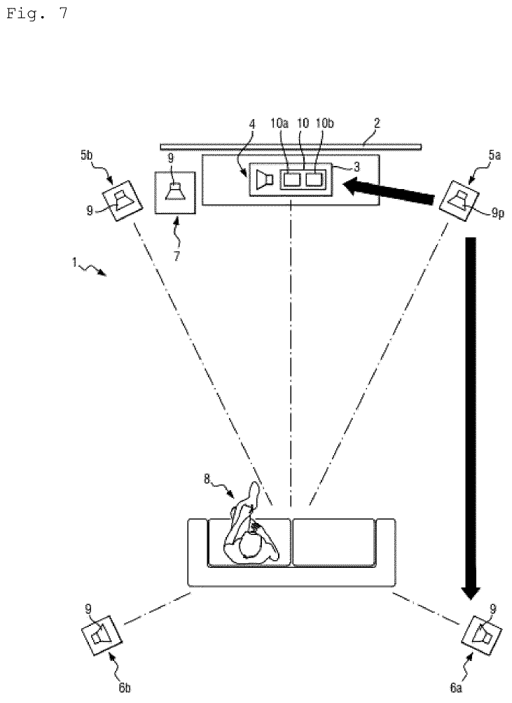

In this case, in reference to FIG. 7, the particular speaker 9p, the operating temperature of which becomes greater than the first predefined temperature threshold is the speaker of a particular side channel, which is, for example, in this case, the front-right channel 5a. The primary audio signal of the front-right channel 5a is applied to the central channel 4 and on the rear-right channel 6a.

The primary audio signal of the front-right channel 5a continues to be partially applied to the front-right channel 5a while being progressively attenuated (for example, for one minute), until the operating temperature of the speaker 9p of the front-right channel 5a becomes less than the second predefined temperature threshold and therefore until a restoration of the temperature which will make the speaker safe after stabilisation. In this case, “partially” means some of the overall level of the primary audio signal.

In the same proportions, the primary audio signal removed from the front-right channel 5a will be offset identically over the speaker 9 of the rear-right channel 6a and over the speaker 9 of the central channel 4, to create a virtual side channel, thus alleviating the speaker 9p of the front-right channel 5a without any degradation nor spatialisation, nor of the overall sound level.

It must be noted that if the system has no rear channel, then all of the primary audio signal of the front-right channel 5a will be offset over the speaker 9 of the central channel 4 to alleviate the speaker in question. In this case, there could be a slight subjective reduction of the spatialisation effect, but without modification of the overall sound level.

This scenario can be applied to another side channel: rear-right, front-left, rear-left.

The third scenario is applicable for an audio system comprising two front side channels and two rear side channels. The particular audio channel, comprising the particular overheating speaker 9p, is a front (or rear) side channel.

In this case, at least some of the overall level of the particular primary audio signal is applied to another side channel on one same side as said particular side channel, and to the other front (or rear) side channel.

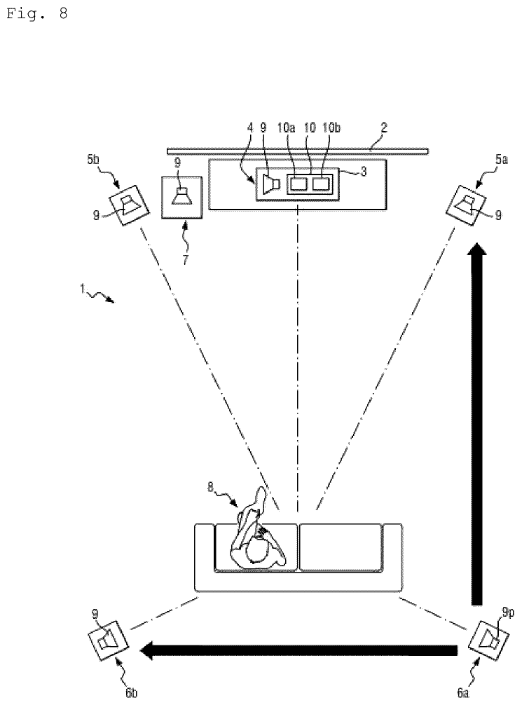

In this case, in reference to FIG. 8, the particular speaker 9p, the operating temperature of which becomes greater than the first predefined temperature threshold is the speaker of the rear-right channel 6a.

The primary audio signal of the rear-right channel 6a is therefore applied to the rear-left channel 6b and to the front-right channel 5a.

The primary audio signal of the rear-right channel 6a will be progressively attenuated (for example, for one minute), until a restoration of the temperature which will make the speaker 9p safe after stabilisation.

The primary audio signal of the rear-right channel 6a therefore continues to be partially applied to the rear-right channel 6a while being progressively attenuated (for example, for one minute), until the operating temperature of the speaker 9p of the rear-right channel 6a becomes less than the second predefined temperature threshold therefore until a restoration of the temperature which will make the speaker safe after stabilisation. In this case, “partially” means some of the overall level of the primary audio signal.

This scenario can be applied to another side channel: front-right, front-left, rear-left.

The fourth scenario is applicable for an audio system comprising a low-frequency channel and at least one other audio channel. The particular audio channel, comprising the particular overheating speaker, is one of the at least one other audio channel.

In this case, frequency components of frequencies less than a predefined frequency threshold of the particular primary audio signal are applied to the low-frequency channel 7. The predefined frequency threshold is, for example, equal to 100 Hz.

It can be provided that a number of particular speakers 9, the operating temperature of which becomes greater than the first predefined threshold, is greater than a predefined number, such that this scenario applies (i.e. a situation in which there are too many overheating speakers). The predefined number is, for example, equal to 3.

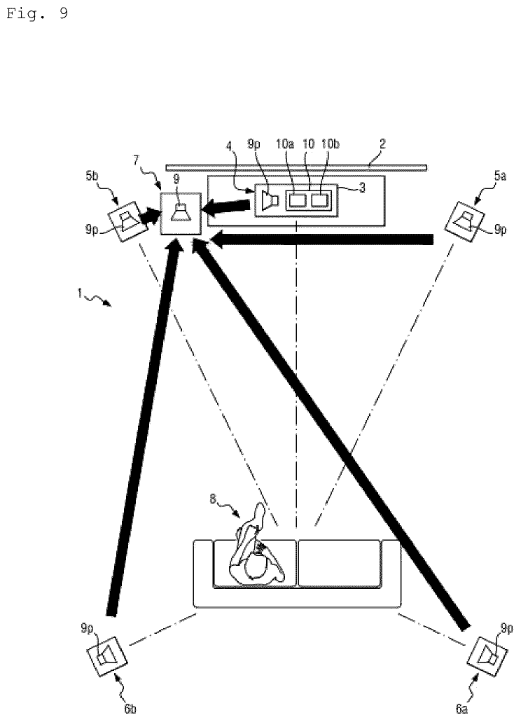

In this case, in reference to FIG. 9, the particular speakers 9p, the operating temperature of which becomes greater than the first predefined temperature threshold are the speakers of the front-right channel 5a, rear-right channel 6a, front-left channel 5b and rear-left channel 6b.

The low-frequency frequency components are then applied to the low-frequency channel 7.

The low frequencies of the primary audio signals of the front-right 5a, rear-right 6a, front-left 5b and rear-left 6b channels will be progressively attenuated (for example, for one minute), until a restoration of the temperature which will make the speakers 9p safe after stabilisation.

The low frequencies of the primary audio signals of the front-right 5a, rear-right 6a, front-left 5b and rear-left 6b channels therefore continue to be applied partially (for example, for one minute), until the operating temperature of the speakers 9p becomes less than the second predefined temperature threshold and therefore until a restoration of the temperature which will make the speakers safe after stabilisation. In this case, “partially” means some of the frequency components.

These scenarios can be combined or implemented successively according to, for example, the temperatures of the non-overheating speakers: it is thus possible, for example, to favour a scenario which does not transfer a signal to a speaker, the temperature of which is high without exceeding the first predefined temperature threshold.

Attention is given to the way in which the particular primary audio signal of a particular audio channel comprising a particular speaker, the temperature of which is too high, is distributed over the other audio channels.

Modifying the primary distribution can consist of applying at least some of an overall level of the particular primary audio signal to at least one other audio channel.

The level of attenuation or gain in each channel is therefore adjusted independently.

To not disrupt the user experience and preserve the tonal balance of the sound, it is necessary to ensure a robustness of the acoustic level by frequency. The primary signal subtracted from the speaker to be made safe is distributed over the speakers of other audio channels according to the following logic. By monitoring the fundamental acoustic properties, the level of the signal to be injected to each speaker can be evaluated to ensure a stable level and tonal balance.

This applies to the distribution of the signal from a speaker enclosure at risk to two supporting side speaker enclosures.

It is considered, before correction, that:
The overall level of the primary audio signal of the speaker 9 of the central channel 4 is equal to L1 [dB];
The overall level of the primary audio signals of the front-right 5a and front-left 5b side channels is L2a [dB] and L2b [dB], respectively.

The processing unit 10 subtracts N dB from the primary signal of the speaker of the central channel 4 and reinjects N2a and N2b over the front-right and front-left side channels 5a and 5b.

The following rating is considered:

$$A B = 20 * log ( {10}^{\frac{A}{20}} + {10}^{\frac{B}{20}} )$$

So, therefore:

$$L 1 L 2 a L 2 b = ( L 1 - N ) ( L 2 a + N 2 a ) ( L 2 b + N 2 b )$$

According to the principles of doubling consistent acoustic sources, the following is thus had:

$$N 2 a = N 2 b = N - 6 dB$$

Now, this applies to the distribution some of the signal from one or more speaker enclosures at risk to a particular audio channel, for example the low-frequency channel 7.

It is considered, before correction, that:
The overall levels of the primary signals of the channels of the speakers at risk are equal to L1 [dB], L2, [dB], L3 [dB] . . . , Li [dB];
The overall level of the primary signal of the low frequency channel is Lc [dB].

The processing unit 10 respectively subtracts N1, N2, . . . , Ni dB from the sources at risk and reinjects Nc dB into the low-frequency channel 7.

The following is had:

$$L 1 L 2 … Li Lc = ( L 1 - N 1 ) ( L 2 - N 2 ) … ( Li - Ni ) ( Lc + Nc )$$

According to the level relationships between consistent acoustic sources, the following is had:

$$Nc = - 20 * log ( \frac{{10}^{\frac{N 1}{10}} + {10}^{\frac{N 2}{10}} + … + {10}^{\frac{Ni}{10}}}{i + 1} )$$

This model is an approach to the possible distribution and can be adapted according to the physical capacities of the speaker enclosures considered.

It must be noted that, in a current audio system, in which the broadcasting method described in this case is not implemented, the spatialisation applied will be optimised for an ideal listening location, also called sweet spot.

The implementation of the broadcasting method makes it possible to maintain the viability of any sweet spot, since the adaptation of the distribution of the multichannel audio signal ensures that the spatial and tonal balance of the sound transmitted into the listening zone is maintained.

If the listener(s) move(s) away from the sweet spot, the spatial balance can be degraded in case of application of the correction algorithm. A listener who is, for example, in the proximity of a side speaker enclosure, to which an audio signal is transferred, will be able to feel the increase of the level on the channel.

It is therefore advantageous to define limits of the level offset and/or broadcast by each channel, in order to ensure a relative spatial balance in the case where the listener(s) move(s) away from the sweet spot. It can be provided, for example, that the signal level offset to another channel is less than a maximum limit.

The case of two listeners far from the sweet spot and each close to one of the speaker enclosures of the system can moreover be considered. In case of a speaker overheating, an audio system according to the prior art would simply reduce the level of the speaker enclosure in danger, which would lead to an obvious imbalance for both listeners, particularly the listener positioned close to the speaker enclosure in danger. The implementation of the broadcasting method will ensure that the information delivered by the safe speaker enclosure is not lost. For a listener far away from the sweet spot, this information will be spatially offset, slightly altering the perception of the original stream. This modification concerns a quite fine perceptual analysis and is considered to be a lesser degradation than the hard-line reduction and loss of information.

In the case where the audio channels are integrated into a compact piece of equipment, like a set-top box, the notion of a sweet spot is must broader, as the speakers of the system are very close together. Modifying the distribution, in case of a speaker overheating, will be a lot less perceptible, as the listener is a similar distance away for each speaker.

The distribution of the multichannel audio signal over the different audio channels is defined by mixing matrices dedicated to the processing of the spatialised sound. These mixing matrices present themselves in the form of input/output connections with variable dimensions, as needed.

In reference to FIG. 10, the mixing matrix 15 is, for example, intended to process a mono (1.0 type) or stereo (2.0 type) audio signal 16, or a multichannel audio signal 17 of Dolby 5.1, Dolby 7.1, DTS 5.1 type, etc. The mixing matrix 15 generates a multichannel audio signal 18 according to the audio system which plays the signal back.

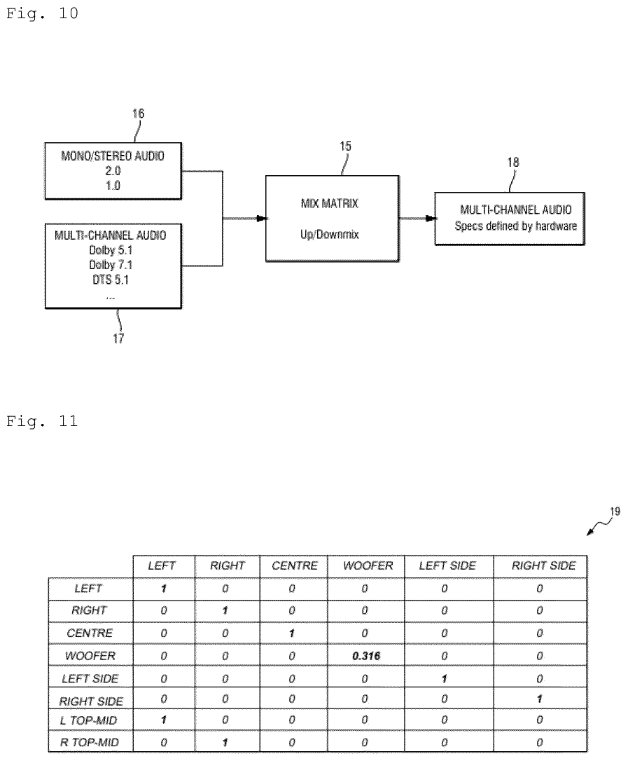

FIG. 11 represents a first mixing matrix 19 used by Dolby, processing audio formats up to the 7.1 format at the input, and generating 5.1 format audio signals at the output.

This first mixing matrix 19 corresponds to the primary multichannel audio distribution used by the processing unit 10 to broadcast the multichannel audio signal.

When the temperature of one or more speakers 9 becomes too high, the processing unit 10 adapts the mixing matrix to adjust the level on one or more speakers 9 of the system at the same time, while respecting the broadcast content.

For this, the processing unit 10 estimates the level of attenuation/gain to be applied (see above) and translates it into the mixing matrix. To handle the digital audio data, the processing unit 10 integrates a conversion from the level in dB to the factor to be applied, by the relationship:

$${c}_{i} = {10}^{\frac{{Ni}_{dB}}{20}}$$

where cᵢ is the factor to be applied to the channel i, the level of attenuation/gain of which will have been estimated at Ni dB by the processing unit 10.

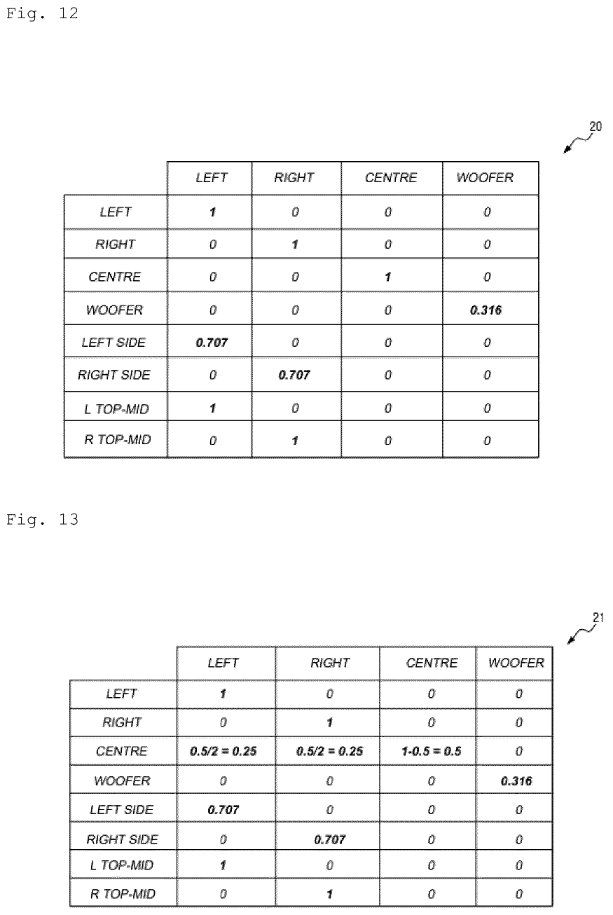

In the case of a set-top box 3 integrating four speakers 9 and forming a 3.1 type system, a second mixing matrix 20 is present, which can be seen in FIG. 12. This matrix aims to acquire a 7.1 format at the input, and to generate 3.1 format audio signals at the output.

Consider the situation of which it is the speaker 9 of the central channel 4 (in the set-top box 3), the temperature of which becomes too high.

The processing unit 10 reduces the level of the primary signal on this speaker 9 and distributes it over the side channels. In the case of a 6 dB attenuation of the central channel 4, the audio signal sent to the central channel is therefore reduced by 0.5 (−6 dB) and is sent over the left channel and the right channel.

The mixing matrix 21 of FIG. 13 is obtained.

The level of the left and right channels has increased, but the creation of the virtual centre channel compensates for this change of level.

It has been seen that modifying the primary distribution can consist of applying at least some of the overall level of the particular primary audio signal to at least one other audio channel.

It is also possible to modify the primary distribution by applying at least some of the frequency components of the particular primary audio signal to at least one other audio channel (see the fourth scenario described above). It is also possible to implement these two methods in combination, if the overheating is too much.

A speaker can indeed be alleviated by attenuating the audio signal which is transmitted to it, but also by changing the frequency distribution of its signal. FIG. 3 shows the dependence between the frequency of the audio signal and the temperature of the speaker.

Distributing some of the spectrum over one or more other speakers 9 makes it possible to alleviate the particular speaker 9p, the temperature of which is too high, without applying a static gain to all of its signal.

With the low frequencies being very slightly or not at all directive, it is advantageous t to rather choose a distribution of the low frequencies of the spectrum to another speaker, in order to minimise the impact on the spatialisation of the sound. The most logical case would be to send the bass/mid-bass parts to the speaker acting as a woofer in the system.

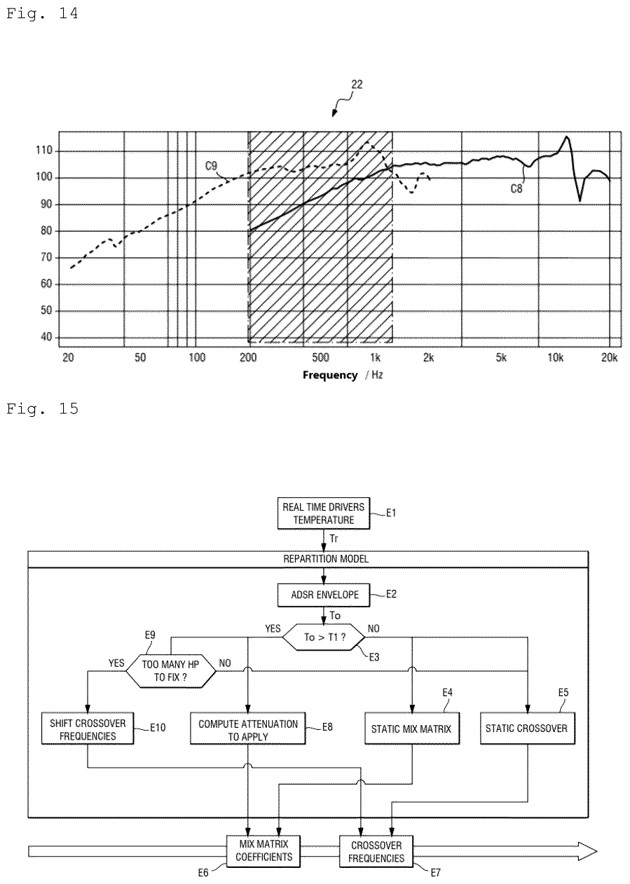

FIG. 14 shows acoustic frequency response measurements of two speakers belonging to a multichannel audio system: the curve C8 is the curve of the speaker 9 of the central channel 4 and the curve C9 is that of the speaker 9 of the low-frequency channel 7.

Modifying the primary distribution, by a different distribution of the frequency components, would make it possible, for example, in the frequency band 22, to send some of the low-frequency signal from the central channel 4 to the low-frequency channel 7.

Modifying the primary distribution consists of modifying (in this case, increasing) the cut-off frequency of the crossover filter which performs the frequency distribution between the different audio channels. The spectrum played back by the low-frequency channel is thus increased, and the spectrum played back by the other channels is thus reduced.

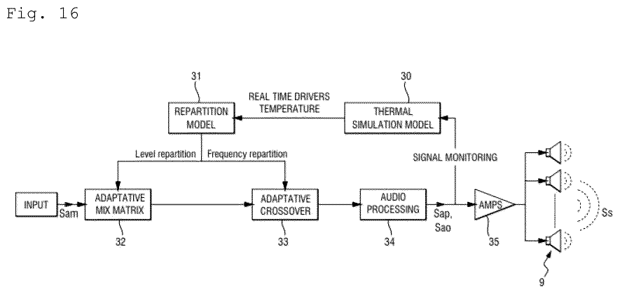

In reference to FIG. 15, the different steps of the broadcasting method are now reminded of.

For each speaker 9, the processing unit 10 evaluates the real-time temperature Tr of said speaker 9 from the levels of the frequency components of the primary audio signal applied to the audio channel comprising said speaker 9: step E1.

The processing unit 10 then applies the ADSR envelope to obtain the operating temperature To of said speaker 9: step E2.

The processing unit 10 compares the operating temperature To with the predefined first temperature threshold T1: step E3.

As long as the operating temperature of all the speakers 9 remains less than (in this case, less than or equal to) the first predefined temperature threshold T1, the processing unit 10 does not modify the mixing matrix (step E4) or the settings (cut-off frequency) of the crossover filter (step E5). The processing unit 10 broadcasts the multichannel audio signal by using the current coefficients of the mixing matrix (step E6) and the current settings of the crossover filter (step E7).

In step E3, if the operating temperature of at least one particular speaker 9p is greater (in this case, strictly) than the first predefined temperature threshold, the processing unit 10 modifies the primary distribution by applying at least some of an overall level of the particular primary audio signal to at least one other audio channel. The processing unit 10 modifies the coefficients of the mixing matrix: step E8.

The processing unit 10 then broadcasts the multichannel audio signal by using the current coefficients of the mixing matrix, which have just been modified (step E6).

In addition, in step E3, if the operating temperature of at least one particular speaker 9p is greater than the first predefined temperature threshold, the processing unit 10 checks the number of speakers, the operating temperature of which is greater than the first predefined temperature threshold: step E9.

If this number is greater than a predefined number, the processing unit 10 modifies the primary distribution by applying the low-frequency frequency components of the particular primary audio signals to at least one audio channel, the speaker of which does not heat up (on the low-frequency channel 7, preferably). For this, the processing unit 10 modifies the cut-off frequency of the crossover filter: step E10. The processing unit 10 broadcasts the multichannel audio signal by using the current settings of the crossover filter, which have just been modified (step E7).

In step E3, if the number is less than the predefined number (in this case, less than or equal to), the processing unit 10 does not modify the settings (cut-off frequency) of the crossover filter (step E5). The processing unit 10 broadcasts the multichannel audio signal by using the current settings of the crossover filter, unmodified (step E7).

The main tests making it possible to determine the action of the model therefore evaluate if the temperatures of the different speakers exceed the first predefined temperature threshold. Subsequently, the distribution of the level in the different audio channels is calculated and translated in terms of coefficients of the mixing matrix. In addition, the number of speakers in question is taken into account to activate the frequency distribution or not. A calculation will then be performed to increase the frequency of the crossover(s) in order to help the speakers to lower their temperature.

If these tests are presented as binary, the effect applied to the audio signal will, in reality, be smoothed by the ADSR envelope applied to the real-time temperature of the speakers. With a well-adjusted envelope, the effect of the different distributions will be returned to 0 before being completely deactivated, with a similarly opposite logic during its activation.

These different steps are combined in a logic described by the block diagram of FIG. 16.

The thermal simulation model 30 analyses the primary audio signals Sap applied at the input of the speakers 9. The processing unit 10 evaluates the real-time temperature, then the operating temperature. The distribution model 31 is implemented. The distribution by level results in an adaptation of the mixing matrix 32. The frequency distribution results in a modification of the crossover filter 33.

The multichannel audio signal Sam is applied at the input of the mixing matrix 32 then at the crossover filter 33. The primary audio signals Sap (if no speaker is overheating) or the optimised audio signals Sao (if at least one speaker is overheating) are processed and shaped by a processing module 34, then amplified by the amplifiers 35 and applied at the input of the speakers 9 which broadcast the sound signal Ss corresponding to the multichannel audio signal Sam.

It must be noted that the primary audio signals Sap, analysed by the thermal simulation model 30, can be the signals at the input or at the output of the amplifiers 35. An audio system could be designed, which can do without a speaker enclosure, replaced by the other supporting speakers. However, the total removal of a speaker enclosure is difficult to achieve, if it is desired to preserve the spatial balance of the sound. The compensation algorithm of the broadcasting method puts a little more stress on the other speakers with respect to their primary use. Consequently, the stresses on the electronics are increased and the thermal risk on the other speakers is also increased. The model is smoothed over a quite long time, but the aim is not for it to be used continuously, but rather occasionally, to overcome certain limitations, following long and intense uses, for example.

The broadcasting method therefore does not make it possible to dispense completely with one or more sources, but rather to optimise the use and longevity of these, by pushing the limitation conditions of the speakers.

The broadcasting method comprises the step of increasing the gain applied to one or more speakers. Consequently, the risk of saturation and damage to the hardware can increase with the action of the broadcasting method. To compensate for this, it is possible to integrate protective devices into the audio system, usually used to limit the voltage level sent to the speakers, and, for example, one or more dynamic limiter(s). Correctly sized (in particular, by a set of ADSR parameters seen above), they make it possible to attenuate a signal when it exceeds a certain threshold (70° C., for example). This attenuation will be very rapid, if the threshold is close to the physical limit of the speaker considered (80° C., for example).

From a playback and frequency point of view, the implementation of the broadcasting method does not degrade the audio system. The cut-off frequency will correspond to that of the hardware components used.

As has been seen, the broadcasting method consists of evaluating the operating temperature of at least one speaker and, if this temperature becomes too high, of applying the particular primary audio signal at least partially to at least one other audio channel.

As has been seen, the operating temperature is not necessarily a current temperature, i.e. a temperature at the present time, but can be a temperature at a future time (“future temperature” is referred to).

The estimation of the future temperature, and therefore the application of the correction in advance, makes it possible for the method to react more rapidly and thus to be able to just apply a weaker correction, thus less audible. Rather than estimating the future temperature, the method can also use a servo loop.

In an embodiment, the particular “future” primary audio signal is known, for example because the processing unit 10 is reading a local file and all of the file is available.

The processing unit 10 can therefore apply the method already described to this future signal to estimate the temperature. The evaluation of the operating temperature is therefore based on an analysis of the particular primary audio signal performed prior to its broadcasting.

In this case, if the processing unit determines that a correction is necessary, the signal actually played will be different from the future signal used to estimate the temperature, since the signal actually played will integrate the correction.

In another, simpler but less effective embodiment, the future temperature is estimated according to the current (present) temperature and the evolution of the temperature in the near past (and therefore, according to a “past temperature”).

For example, if T_{c} (t) denotes the current temperature and T_{c} (t−1) denotes the temperature 1 second in the past, the temperature 1 second in the future can be estimated with the formula:

$${T}_{f} ( t ) = {T}_{c} ( t ) + ( {T}_{c} ( t ) - {T}_{c} ( t - 1 ) ) .$$

In another embodiment, the processing unit 10 implements a servo controller (or corrector).

The servo controller is a module which receives at the input, a setpoint and a measurement, and which produces, at the output, a command which, when it is applied to a system, tends to bring the measurement closer to the setpoint.

The setpoint, in this case, is the desired maximum temperature Tₘₐₓ, set a little below the limit not to be exceeded, since the usual controllers tend to oscillate around the setpoint, and therefore to exceed it a little.

The measurement is the current temperature estimated by the temperature evaluation method described above.

The command represents the part G_{c} (t) of the particular primary audio signal to be redistributed to other speakers when it is negative (in decibels).

An example of an implementation using a usual Proportional-Integral-Derivative (PID) controller is presented.

The following steps are repeated at regular intervals.

The processing unit 10 first estimates the current temperature T_{c} (t).

The controller then calculates the difference Δ (t) between the maximum temperature and the current temperature:

$$Δ ( t ) = {T}_{max} - {T}_{c} ( t )$$

Then, the controller calculates the proportional P_{c} (t), integral I_{c} (t) and derivative D_{c} (t) terms:

$${P}_{c} ( t ) = P \times Δ ( t ) \\ {I}_{c} ( t ) = min ( {I}_{c} ( t - 1 ) + I \times Δ ( t ) , 0 ) \\ {D}_{c} ( t ) = D \times ( Δ ( t ) - Δ ( t - 1 ) )$$

where P, I and D are predetermined constants which make it possible to set the reactivity and stability of the controller.

In this case, a difference with respect to a conventional PID controller is observed. Usually, either the following is rather used:

$${I}_{c} ( t ) = ( {I}_{c} ( t - 1 ) + I \times Δ ( t ) ) , \\ or : \\ {I}_{c} ( t ) = clamp ( {I}_{c} ( t - 1 ) + I \times Δ ( t ) , {I}_{min} , {I}_{max} ) ,$$

with Iₘᵢₙ<0 and Iₘₐₓ>0 and predetermined.

The command is then given by:

$${G}_{c} ( t ) = {P}_{c} ( t ) + {I}_{c} ( t ) + {D}_{c} ( t ) .$$

It must be noted that this embodiment is a generalisation of the embodiment mentioned above and consisting of estimating the future temperature according to the current temperature and the past temperature.

The term P_{c} (t) corresponds to the use of the current temperature, and the term D_{c} (t) adds the taking into account of the future temperature.

In particular, if P=D and I=0 is posed, the following is obtained:

$${G}_{c} ( t ) = P \times ( T max - ( {T}_{o} ( t ) + ( {T}_{o} ( t ) - {T}_{o} ( t - 1 ) ) ) ) = P \times ( {T}_{max} - {T}_{f} ( t ) )$$

which corresponds exactly to the use of the future temperature T_{f} (t) like in said embodiment mentioned above.

Naturally, the invention is not limited to the embodiments described, but comprises any variant entering into the scope of the invention such as defined by the claims.

The broadcasting method does not necessarily comprise the monitoring of the temperature of all the speakers. It is possible to monitor only one or more “at risk” speakers.

As has been seen, the broadcasting method can be implemented, whatever the multichannel audio system. The speakers can be integrated into any number of pieces of equipment, and even into one single piece of equipment, which can be a set-top box, a soundbar, a speaker enclosure, etc.

The equipment in question can therefore, in particular, be a set-top box.

The set-top can integrate at least one speaker of the plurality of audio channels used in the implementation of the broadcasting method.

The set-top box can thus integrate all the speakers used. In this case, the set-top box integrates the processing unit, the audio amplifiers and at least two speakers, and for example, four speakers forming four audio channels (left, right, centre and bass).

The set-top box can also integrate one or more speakers, the other speakers used (for example, those of the rear channels) being offset.

All the speakers can also be positioned outside of the set-top box.

The processing unit, in which the broadcasting method is implemented, can be integrated in one or more pieces of equipment belonging or not to the multichannel audio system (the broadcasting method could be implemented remotely, on a cloud server, for example).

1. A method for broadcasting a multichannel audio signal (Sam) by an audio system comprising a plurality of audio channels, each comprising at least one speaker, the broadcasting method being implemented by a processing unit and comprising:
broadcasting the multichannel audio signal by using a primary distribution of the multichannel audio signal, which defines a primary audio signal (Sap) for each audio channel, and by applying said primary audio signals to the audio channels;
evaluating an operating temperature (To) of at least one particular speaker (9p) belonging to a particular audio channel;
when the operating temperature of the particular speaker becomes greater than a first predefined temperature threshold, modifying the primary distribution to obtain an optimised distribution of the multichannel audio signal, in which a particular primary audio signal of the particular audio channel is applied at least partially to at least one other audio channel, the optimised distribution thus defining an optimised audio signal (Sao) for each audio channel; and
broadcasting the multichannel audio signal by applying the optimised audio signals to the audio channels until the operating temperature of the particular speaker becomes less than a second predefined temperature threshold.

2. The method for broadcasting according to claim 1, wherein modifying the primary distribution comprises applying at least some of an overall level of the particular primary audio signal (Sap) to at least one other audio channel.

3. The method for broadcasting according to claim 2, wherein the plurality of audio channels comprise a central channel and two side channels, the particular audio channel being the central channel, at least some of the overall level of the particular primary audio signal being applied to the two side channels.

4. The method for broadcasting according to to claim 2, wherein the plurality of audio channels comprise a central channel, two front side channels and two rear side channels, the particular audio channel being a particular side channel, at least some of the overall level of the particular primary audio signal being applied to the central channel and to another side channel on one same side as the said particular side channel.

5. The method for broadcasting according to claim 2, wherein the plurality of audio channels comprise two front side channels and two rear side channels, the particular audio channel being a front (or rear) side channel, at least some of the overall level of the particular primary audio signal being applied to another side channel on one same side as said particular side channel, and to the other front (or rear) side channel.

6. The method for broadcasting according to claim 1, wherein modifying the primary distribution comprises applying at least some frequency components of the particular primary audio signal (Sap) to at least one other audio channel.

7. The method for broadcasting according to claim 6, wherein modifying the primary distribution comprises modifying a cut-off frequency of a crossover filter.

8. The method for broadcasting according to claim 6, wherein the plurality of audio channels comprise a low-frequency channel and at least one other audio channel, the particular audio channel being one of the at least one other audio channel, frequency components of frequencies less than a predefined frequency threshold of the particular primary audio signal being applied to the low-frequency channel.

9. The method for broadcasting according to claim 6, wherein said applying at least some of the frequency components of the particular primary audio signal (Sap) to at least one other audio channel is implemented if a number of particular speakers, the operating temperature of which becomes greater than the first predefined temperature threshold (T1), is greater than a predefined number.

10. The method for broadcasting according to claim 1, wherein the particular primary audio signal continues to be partially applied to the particular audio channel until the operating temperature of the particular speaker becomes less than the second predefined temperature threshold.

11. The method for broadcasting according to claim 10, wherein the particular primary audio signal is progressively attenuated over the particular audio channel.

12. The method for broadcasting according to claim 1, wherein the evaluation of the operating temperature of the particular speaker comprises:
performing a frequency analysis of the particular primary audio signal to evaluate levels of different frequency components of the particular primary audio signal; and
evaluating a real-time temperature of the particular speaker according to said levels.

13. The method for broadcasting according to claim 12, further comprising applying an ADSR envelope to the real-time temperature to obtain the operating temperature.

14. The method for broadcasting according to claim 1, wherein the operating temperature is a future temperature.

15. The method for broadcasting according to claim 14, wherein the evaluation of the operating temperature is based on an analysis of the particular primary audio signal performed prior to its broadcasting.

16. The method for broadcasting according to claim 14, wherein the evaluation of the operating temperature is performed from a past temperature and a current temperature.

17. The method for broadcasting according to claim 1, further comprising implementing a servo controller, which receives, at the input, a setpoint and a measurement, and which produces, at the output, a command, the setpoint being a maximum temperature, the measurement being the evaluation of the operating temperature (To), and the command being some of the particular primary audio signal to be applied to the at least one other audio channel.

18. A piece of equipment comprising a processing unit, wherein the broadcasting method according to claim 1 is implemented.

19. The piece of equipment according to claim 18, wherein the piece of equipment is a set-top box.

20. The piece of equipment according to claim 19, wherein the set-top box integrates at least one speaker of the plurality of audio channels.

21. (canceled)

22. A non-transitory computer-readable recording medium, on which a computer program is recorded, the computer program comprising instructions which make a processing unit of a piece of equipment carry out the broadcasting method according to claim 1, when said program is executed by the processing unit.
